(19) United States
(12) Patent Application Publication
(10) Pub. No.: US 2013/0243330 A1
(43) Pub. Date: Sep. 19, 2013

(54) METHOD AND APPARATUS FOR CONSTRUCTING IMAGE BLUR PYRAMID, AND AN IMAGE FEATURE EXTRACTING CIRCUIT

(71) Applicants: Liang-Chi Chiu, Baoshan Township (TW); Yen-Chung Chang, Hsinchu City (TW); Jiun-Yan Chen, Tuku Township (TW); Jwu-Sheng Hu, Hsinchu City (TW); Tian-Sheuan Chang, Hsinchu City (TW)

(72) Inventors: Liang-Chi Chiu, Baoshan Township (TW); Yen-Chung Chang, Hsinchu City (TW); Jiun-Yan Chen, Tuku Township (TW); Jwu-Sheng Hu, Hsinchu City (TW); Tian-Sheuan Chang, Hsinchu City (TW)

(73) Assignee: INDUSTRIAL TECHNOLOGY RESEARCH INSTITUTE, HSINCHU (TW)

(21) Appl. No.: 13/589,336

(22) Filed: Aug. 20, 2012

(30) Foreign Application Priority Data
Mar. 15, 2012 (TW) 101108955

(51) Int. Cl. G06K 9/40; G06K 9/46

(52) U.S. Cl. 382/195; 382/264

(57) ABSTRACT

A method and an apparatus for constructing an image blur pyramid, and an image feature extracting circuit are disclosed. The image blur pyramid construction apparatus comprises a first image blur circuit, a second image blur circuit and an image sub-sampler. The first image blur circuit and the second image blur circuit simultaneously generate a first interval and a second interval in the same octave according to an input image, a first filter and a second filter. The dimension of the second filter is greater than that of the first filter. The image sub-sampler couples with the second image blur circuit and down samples the second interval to generate a sub-sample image.

This application claims the benefit of Taiwan application Serial No. 101108955, filed Mar. 15, 2012, the disclosure of which is incorporated by reference herein in its entirety.

### BACKGROUND

1. Technical Field

The disclosure relates in general to a method and an apparatus for constructing an image blur pyramid, and an image feature extracting circuit.

2. Description of the Related Art

A feature descriptor refers to a descriptor which most represents the feature points. The feature descriptor may be obtained by such as the scale invariant feature transform (SIFT). The scale invariant feature transform comprises the following steps. Firstly, an input image of the to-be-extracted feature points is Gaussian blurred and subsampled for many times to construct an image blur pyramid. Then, image difference is performed on the interval of the same resolution to generate a plurality of difference of Gaussian (DoG) images. Then, the max (or min) pixels whose values are greater (or smaller) than the values of a plurality of adjacent pixels are located from the DoG image with reference to the DoG image of an adjacent layer. The feature point is formed by such pixel points with max/min pixel values.

After the feature points are located, the scale invariant feature transform constructs a window according to the image locations of the feature points, and calculates the intensity gradient vectors between every two adjacent pixel points of a block. Then, a histogram of the gradient vectors inside the window is calculated, and the peak gradient directions of the histogram are located and used as the orientation of the feature points. The vector directions of subsequently generated descriptors of the feature points are denoted with the angle relative to the orientation. Then, another window is constructed according to the image locations of the feature points, wherein the size of the other window may not be the same with that of the window based on the directions of the orientation of the feature points. The window is divided into a plurality of sub-blocks. Each block contains a plurality of gradient vector histograms. Each histogram contains a plurality of gradient vector directions. The vector values of the descriptor of a feature point are obtained by weighting and normalizing the values of each gradient vector direction.

Referring to FIG. 1, a first conventional method for constructing an image blur pyramid is shown. The first conventional method for constructing an image blur pyramid comprises the following steps. Firstly, an input image S[0] is blurred according to a Gaussian filter F[0] to generate an interval S[1]. Next, the interval S[1] is blurred according to a Gaussian filter F[1] to generate an interval S[2]. Then, the interval S[2] is blurred according to a Gaussian filter F[2] to generate an interval S[3]. The input image S[0], the interval S[1], the interval S[2] and the interval S[3] together constitute an octave O[0] of an image blur pyramid.

The interval S[3] is sub-sampled to generate a sub-sample image S[4] whose resolution is lower than that of the interval S[3]. After that, the sub-sample image S[4] is blurred according to a Gaussian filter F[3] to generate an interval S[5]. Following that, the interval S[5] is blurred according to a Gaussian filter F[4] to generate an interval S[6]. Then, the interval S[6] is blurred according to a Gaussian filter F[5] to generate an interval S[7]. The sub-sample image S[4], the interval S[5], the interval S[6] and the interval S[7] together constitute an octave O[1] of an image blur pyramid.

Referring to FIG. 2, a second conventional method for constructing an image blur pyramid is shown. The second conventional method for constructing an image blur pyramid comprises the following steps: Firstly, an input image is integrated to generate an integral image I[0]. Next, a mean filter M[0] blurs an integral image I[0] to generate an interval S[1]. Then, a mean filter M[1] blurs the interval S[1] to generate an interval S[2]. After that, a mean filter M[2] blurs the interval S[2] to generate an interval S[3]. The input image S[0], the interval S[1], the interval S[2] and the interval S[3] together constitute an octave O[0] of an image blur pyramid.

The interval S[3] is integrated to generate an integral image I[1], and the integral image I[1] is subsampled to generate a sub-sample image S[4] whose resolution is lower than that of the interval S[3]. Next, a mean filter M[3] blurs the sub-sample image S[4] to generate an interval S[5]. Then, a mean filter M[4] blurs the interval S[5] to generate an interval S[6]. After that, a mean filter M[5] blurs the interval S[6] to generate an interval S[7]. The sub-sample image S[4], the interval S[5], the interval S[6] and the interval S[7] together constitute an octave O[1] of an image blur pyramid.

Regardless of the first or the second conventional method for constructing an image blur pyramid, the frames in the same octave need to be calculated in order, hence resulting in dependency between the frames in the same octave. Thus, the conventional methods for constructing an image blur pyramid require a large amount of computation time for constructing an image blur pyramid.

### SUMMARY

The disclosure is directed to a method and an apparatus for constructing an image blur pyramid, and an image feature extracting circuit.

According to one embodiment, an image blur pyramid construction method is disclosed. The image blur pyramid construction method comprises the following steps: An input image is read from a memory. A first filter and a second filter are respectively read from a first filter register and a second filter register, wherein the dimension of the second filter is greater than that of the first filter. A first interval and a second interval in the same octave are simultaneously generated according to the input image, the first filter and the second filter. The second interval is down sampled to generate a sub-sample image.

According to another embodiment, an apparatus for constructing an image blur pyramid is disclosed. The image blur pyramid construction apparatus comprises a first image blur circuit, a second image blur circuit and an image sub-sampler. The first image blur circuit and the second image blur circuit simultaneously generate a first interval and a second interval in the same octave according to an input image, a first filter and a second filter. The dimension of the second filter is greater than that of the first filter. The image sub-sampler couples with the second image blur circuit and down samples the second interval to generate a sub-sample image.

According to an alternative embodiment, an image feature extracting circuit is disclosed. The image feature extracting circuit comprises an image blur pyramid construction apparatus and an image feature generation apparatus. The image blur pyramid construction apparatus comprises a first image blur circuit, a second image blur circuit and an image sub-sampler. The first image blur circuit and the second image blur circuit simultaneously generate a first interval and a second interval in the same octave according to an input image, a first filter and a second filter. The dimension of the second filter is greater than that of the first filter. The image sub-sampler couples with the second image blur circuit and down samples the second interval to generate a sub-sample image. The image feature generation apparatus generates an image feature descriptor according to the first interval and the second interval.

### BRIEF DESCRIPTION OF THE DRAWINGS

FIG. 1 shows a first conventional method for constructing an image blur pyramid;

FIG. 2 shows a second conventional method for constructing an image blur pyramid;

FIG. 3 shows an image feature extracting system;

FIG. 4 shows an image feature extracting circuit;

FIG. 5 shows an image blur pyramid construction apparatus according to a first embodiment;

FIG. 6 shows a flowchart of a method for constructing an image blur pyramid according to a first embodiment;

FIG. 7 shows a filter F′[0];

FIG. 8 shows a filter F′[1];

FIG. 9 shows a filter F′[2];

FIG. 10 shows an image blur circuit;

FIG. 11 shows an image sub-sampler;

FIG. 12 shows an image blur pyramid construction apparatus according to a second embodiment;

FIG. 13 shows a flowchart of a method for constructing an image blur pyramid according to a second embodiment;.

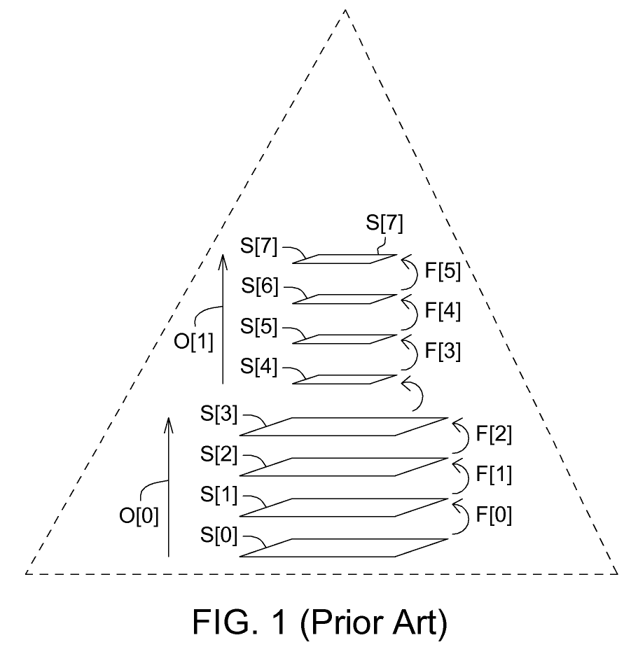

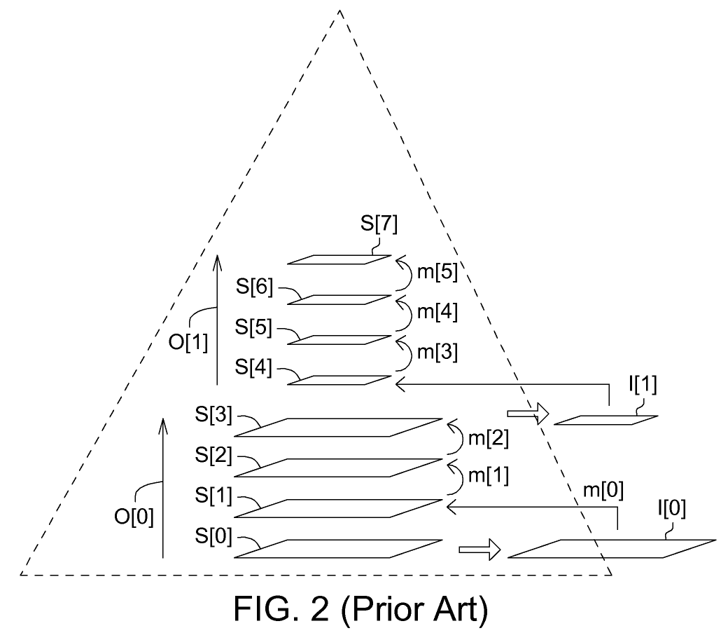

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

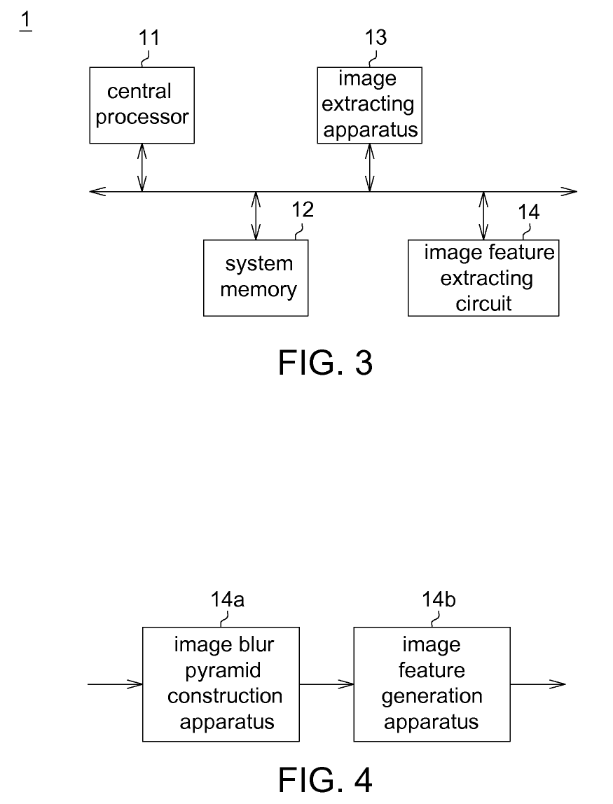

Referring to FIG. 3 and FIG. 4, a system and a circuit for extracting an image feature are respectively shown. The image feature extracting system 1 comprises a central processor 11, a system memory 12, an image extracting apparatus 13 and an image feature extracting circuit 14. The image extracting apparatus 13 is realized by such as a video recorder. The central processor 11 activates the image extracting apparatus 13 to extract an original image. The image extracting apparatus 13 extracts and stores the original image to the system memory 12. The image feature extracting circuit 14 reads the original image from the system memory 12 and further extracts the feature from the original image to generate a feature descriptor. Furthermore, the image feature extracting circuit 14 comprises an image blur pyramid construction apparatus 14a and an image feature generation apparatus 14b. The image blur pyramid construction apparatus 14a is for constructing an image blur pyramid. The image feature generation apparatus 14b generates a feature descriptor according to the intervals of the image blur pyramid.

### First Embodiment

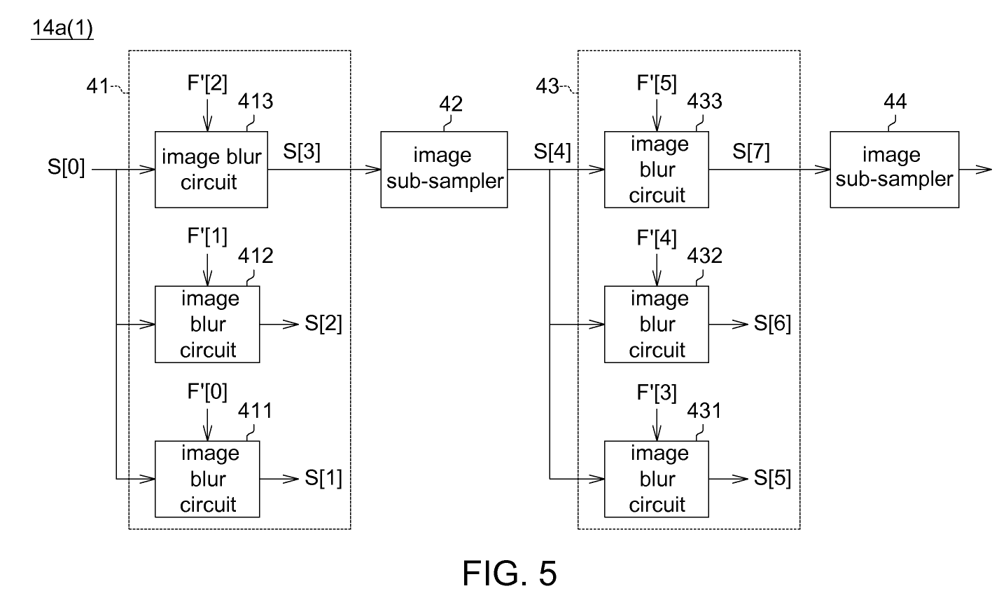

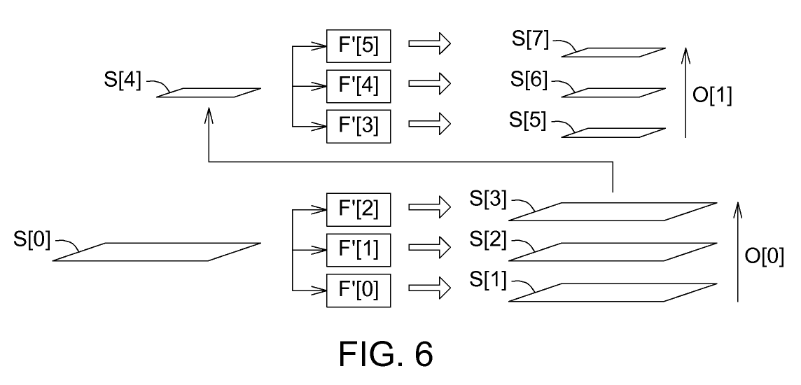

Referring to FIG. 5 and FIG. 6, an apparatus and a method for constructing an image blur pyramid according to a first embodiment are respectively shown. In the first embodiment, the image blur pyramid construction apparatus 14a is designated by the image blur pyramid construction apparatus 14a(1). For convenience of elaboration, the image blur pyramid construction apparatus 14a(1) of FIG. 5 comprises two octave construction circuits and two image sub-samples, and the octave construction circuits comprises three image blur circuits. However, the practical applications are not limited to the above exemplification, and the quantities of octave construction circuits, image sub-sampler and image blur circuits may be flexibly adjusted according to the degree of image blur required in practical applications.

The image blur pyramid construction apparatus 14a(1) comprises an octave construction circuit 41, an image sub-sampler 42, an octave construction circuit 43 and an image sub-sampler 44. The octave construction circuit 41 comprises image blur circuits 411, 412 and 413. The octave construction circuit 43 comprises image blur circuits 431, 432 and 433.

The image blur circuits 411, 412 and 413 simultaneously generate intervals S[1], S[2] and S[3] in an octave O[0] according to an input image S[0], and filters F′[0], ′F[1] and F′[2]. The dimension of filter F′[2] is greater than that of filter ′F[1]. The dimension of filter ′F[1] is greater than that of filter F′[0]. Since the intervals S[1], S[2] and S[3] of the octave O[0] are simultaneously generated, the required computation time for constructing an image blur pyramid is thus reduced.

The image sub-sampler 42 couples with the image blur circuit 413 and down samples the interval S[3] to generate a sub-sample image S[4]. The sub-sample image S[4] is used as an input image of the octave construction circuit 43 of the next level. The image blur circuits 431, 432 and 433 of the octave construction circuit 43 simultaneously generate intervals S[5], S[6] and S[7] of the octave O[1] respectively according to the sub-sample image S[4], and the filters F′[3], ′F[4] and F′[5]. The dimension of filter F′[5] is greater than that of filter F′[4], and the dimension of filter ′F[4] is greater than that of filter F′[3]. Since the intervals S[5], S[6] and S[7] of the octave O[1] are simultaneously generated, the required computation time for constructing an image blur pyramid is thus reduced.

Furthermore, the image blur circuits 411, 412 and 413 respectively read the filters F′[0], ′F[1] and F′[2] from corresponding filter registers, blur the input image S[0] according to the filters F′[0], ′F[1] and F′[2] to simultaneously generate intervals S[1], S[2] and S[3]. After the image sub-sampler 42 sub-samples the interval S[3], the image blur circuits 431, 432 and 433 respectively read the filters F′[3], ′F[4] and F′[5] from corresponding filter registers, and blur sub-sample image S[4] according to the filters F′[3], ′F[4] and F′[5] to simultaneously generate the intervals S[5], S[6] and S[7]. The image sub-sampler 44 couples with image blur circuit 433 and down samples interval S[7] to generate another sub-sample image. In practical application, more octave construction circuits and image sub-samplers may be added to increase the number of octaves of the image blur pyramid.

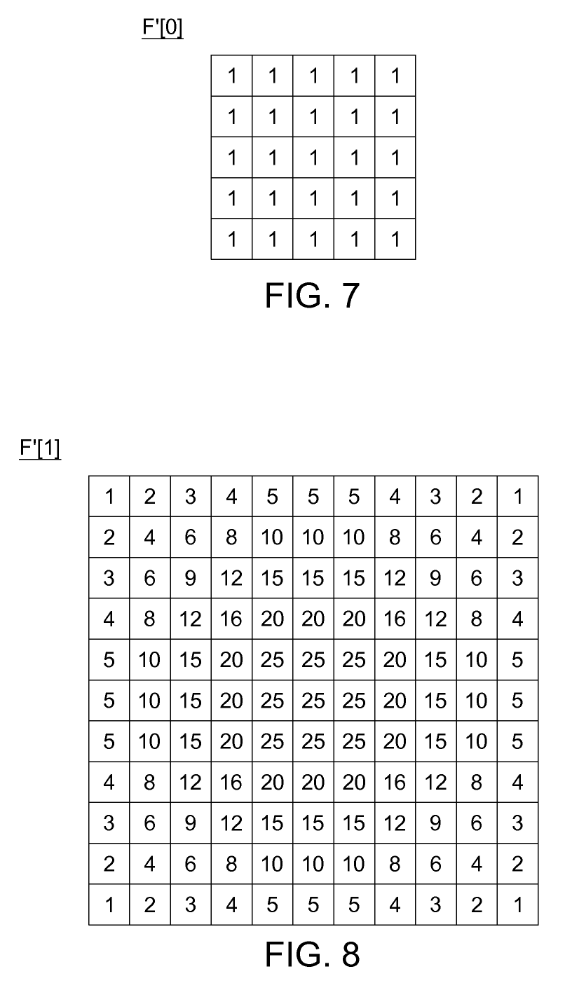

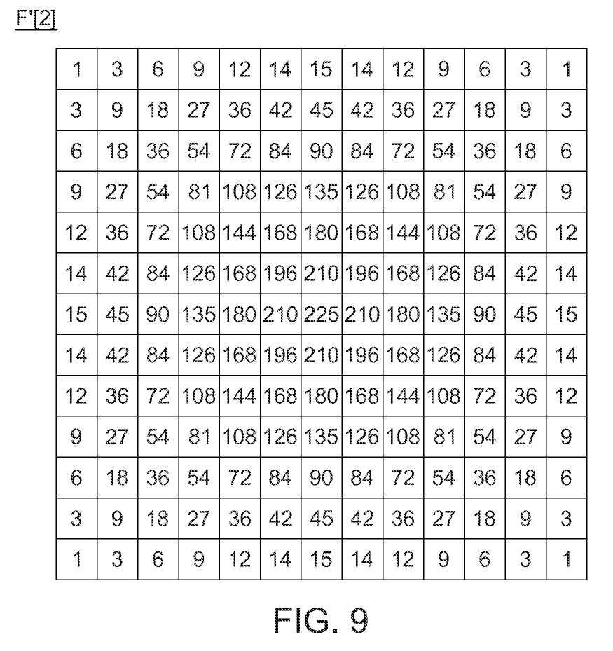

Referring to FIG. 7, FIG. 8 and FIG. 9, filters F′[0], F′[1] and F′[2] are respectively shown. For example, the dimension of the filter F′[0] is 5×5; the dimension of the filter F′[1] is 11×11; the dimension of the filter F′[2] is 13×13. That is, the filters F′[0], F′[1] and F′[2] are realized by 25, 121 and 169 filters respectively. The filter F′[0] is realized by such as a Gaussian filter F[0]. The filter F′[1] is associated with the convolution of the filter F′[0] and a Gaussian filter F[1]. The filter F′[2] is associated with the convolution of the filter F′[1] and a Gaussian filter F[2]. In an embodiment, the filter F′[1] is equivalent to the convolution of the filter F′[0] and the Gaussian filter F[1], and the filter F′[2] is equivalent to the convolution of the filter F′[1] and the Gaussian filter F[2].

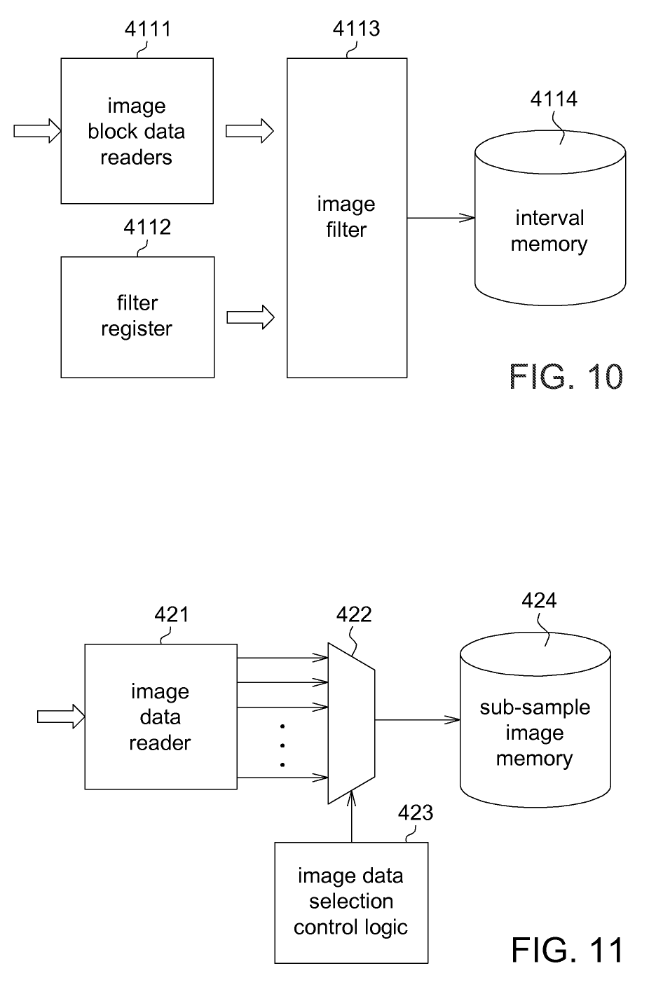

Referring to FIG. 10, an image blur circuit is shown. The image blur circuit comprises an image block data readers 4111, a filter register 4112, an image filter 4113 and an interval memory 4114. In the embodiment of FIG. 10, the interval memory 4114 is disposed inside the image blur circuit. However, in another embodiment, the interval memory 4114 may be disposed outside the image blur circuit. The image block data reader 4111 is used for reading an input image. If the mage blur circuit is located in the octave construction circuit of the first level, then the image block data reader 4111 reads an original image from the system memory and uses the original image as an input image. Conversely, if the image blur circuit is not located in the octave construction circuit of the first level, then the image block data reader 4111 reads a sub-sample image from the sub-sample image memory of the image sub-sampler of the previous level and uses the sub-sample image as an input image.

The filter register 4112 stores a filter corresponding to the image filter 4113. The filter stored in the filter register 4112 may be realized by storing filter. The image filter 4113 that reads the filter stored in the filter register 4112 may be realized by reading filter. The image filter 4113 reads the filter stored in the filter register 4112, and blurs the input image according to the filter stored in the filter register 4112 to generate an interval. The interval memory 4114 is used for storing the blurred interval.

Referring to FIG. 11, an image sub-sampler is shown. The image sub-sampler comprises an image data reader 421, a multiplexer 422, an image data selection control logic 423 and a sub-sample image memory 424. The image data reader 421 reads an interval from an image blur circuit. The image data selection control logic 423 controls the multiplexer 422 to sub-sample the interval to generate a sub-sample image. The sub-sample image is generated by reducing the resolution of the interval. For example, the multiplexer 422 selects and outputs every one of four pixels. The sub-sample image memory 424 is used for storing the sample image.

### Second Embodiment

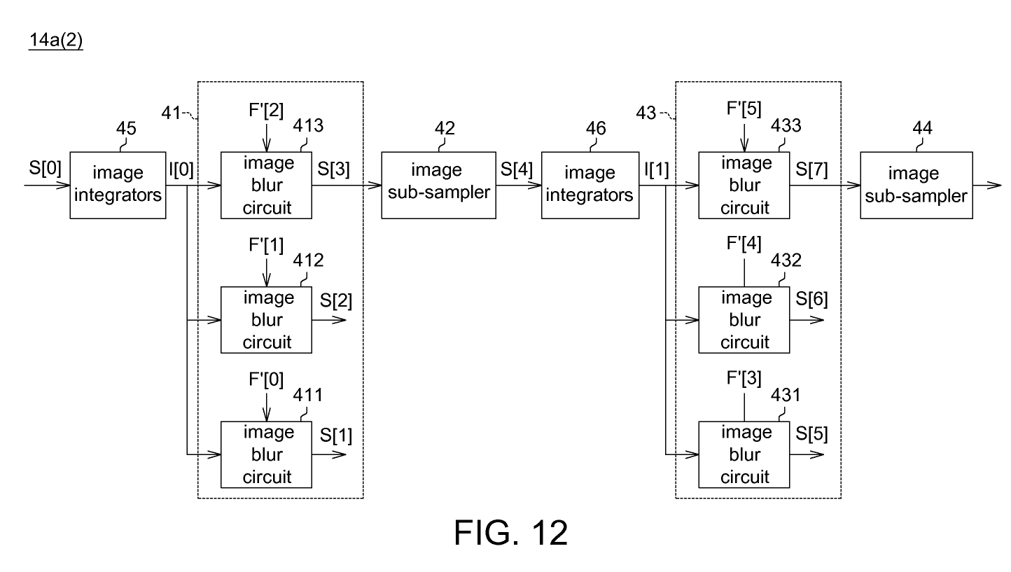

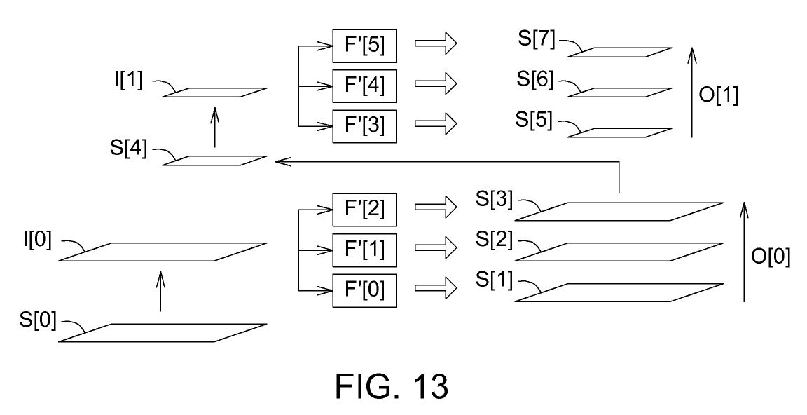

Referring to FIG. 12 and FIG. 13, an apparatus and a method for constructing an image blur pyramid according to a second embodiment are respectively shown. The second embodiment is different the first embodiment mainly in that the image blur pyramid construction apparatus 14a(2) further comprises image integrators 45 and 46 in addition to the octave construction circuit 41, the image sub-sampler 42, the octave construction circuit 43 and the image sub-sampler 44.

The image integrator 45 integrates an input image S[0] to generate an integral image I[0]. The image blur circuits 411, 412 and 413 respectively read filters F′[0], F′[1] and F′[2] from corresponding filter registers, and blur the integral image I[0] according to the filters F′[0], ′F[1] and F′[2] to simultaneously generate intervals S[1], S[2] and S[3]. After the image sub-sampler 42 sub-samples interval S[3], the image integrator 46 integrates a sub-sample image S[4] to generate the integral image I[1]. The image blur circuits 431, 432 and 433 respectively read filters F′[3], F′[4] and F′[5] from corresponding filter registers, and blur the integral image I[1] according to the filters F′[3], F′[4] and F′[5] to simultaneously generate intervals S[5], S[6] and S[7]. The image sub-sampler 44 couples with image blur circuit 433 and down samples interval S[7] to generate another sub-sample image. In practical application, more octave construction circuits and image sub-samplers may be added to increase the number of octaves of the image blur pyramid.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image blur pyramid construction method, comprising:
reading an input image from a memory;
reading a first filter and a second filter from a first filter register and a second filter register respectively, wherein the dimension of the second filter is greater than that of the first filter;
simultaneously generating a first interval and a second interval in an octave according to the input image, the first filter and the second filter; and
down sampling the second interval to generate a first sub-sample image.

2. The image blur pyramid construction method according to claim 1, wherein in the blurring step, the input image is blurred according to the first filter and the second filter to simultaneously generate the first interval and the second interval.

3. The image blur pyramid construction method according to claim 1, further comprising:
integrating the input image to generate an integral image;
wherein, in the blurring step, the integral image is blurred according to the first filter and the second filter to simultaneously generate the first interval and the second interval.

4. The image blur pyramid construction method according to claim 1, wherein the second filter is associated with the convolution of the first filter and a Gaussian filter.

5. The image blur pyramid construction method according to claim 1, further comprising:
reading a third filter from a third filter register;
reading a fourth filter from a fourth filter register, wherein the dimension of the fourth filter is greater than that of the third filter; and
blurring the first sub-sample image according to the first sub-sample image, the third filter and the fourth filter to simultaneously generate a third interval and a fourth interval in a second octave, wherein the dimension of the fourth filter is greater than that of the third filter.

6. The image blur pyramid construction method according to claim 5, further comprising:
sub-sampling the fourth interval to generate a second sub-sample image.

7. An image blur pyramid construction apparatus, comprising:
a first image blur circuit;
a second image blur circuit, wherein the first image blur circuit and the second image blur circuit simultaneously generate a first interval and a second interval in an octave according to an input image, a first filter and a second filter, and the dimension of the second filter is greater than that of the first filter; and
a first image sub-sampler, which couples with the second image blur circuit and down samples the second interval to generate a first sub-sample image.

8. The image blur pyramid construction apparatus according to claim 7, wherein the first image blur circuit and the second image blur circuit blur the input image according to the first filter and the second filter to simultaneously generate the first interval and the second interval.

9. The image blur pyramid construction apparatus according to claim 7, further comprising:
an image integrator used for integrating the input image to generate an integral image;
wherein, the first image blur circuit and the second image blur circuit blur the integral image according to the first filter and the second filter to simultaneously generate the first interval and the second interval.

10. The image blur pyramid construction apparatus according to claim 7, wherein the second filter is associated with the convolution of the first filter and a Gaussian filter.

11. The image blur pyramid construction apparatus according to claim 7, further comprising:
a third image blur circuit; and
a fourth image blur circuit, wherein the third image blur circuit and the fourth image blur circuit blur the first sub-sample image according to the first sub-sample image, a third filter and a fourth filter to simultaneously generate a third interval and a fourth interval in a second octave, and the dimension of the fourth filter is greater than that of the third filter.

12. The image blur pyramid construction apparatus according to claim 11, further comprising:
a second image sub-sampler, which couples with the fourth image blur circuit and down samples the fourth interval to generate a second sub-sample image.

13. An image feature extracting circuit, comprising:
an image blur pyramid construction apparatus, comprising:
a first image blur circuit;
a second image blur circuit, wherein the first image blur circuit and the second image blur circuit simultaneously generate a first interval and a second interval in an octave according to an input image, a first filter and a second filter, and the dimension of the second filter is greater than that of the first filter; and
a first image sub-sampler, which couples with the second image blur circuit and down samples the second interval to generate a first sub-sample image; and
an image feature generation apparatus used for generating a plurality of image feature descriptors according to the first interval and the second interval.

14. The image feature extracting circuit according to claim 13, wherein the first image blur circuit and the second image blur circuit blur the input image according to the first filter and the second filter to simultaneously generate the first interval and the second interval.

15. The image feature extracting circuit according to claim 13, further comprising:
an image integrator used for integrating the input image to generate an integral image;
wherein, the first image blur circuit and the second image blur circuit blur the integral image according to the first filter and the second filter to simultaneously generate the first interval and the second interval.

16. The image feature extracting circuit according to claim 13, wherein the second filter is associated with the convolution of the first filter and a Gaussian filter.

17. The image feature extracting circuit according to claim 13, further comprising:
a third image blur circuit; and
a fourth image blur circuit, wherein the third image blur circuit and the fourth image blur circuit blur the first sub-sample image according to the first sub-sample image, a third filter and a fourth filter to simultaneously generate a third interval and a fourth interval in a second octave, and the dimension of the fourth filter is greater than that of the third filter.

18. The image feature extracting circuit according to claim 17, further comprising:
a second image sub-sampler, which couples with the fourth image blur circuit and down samples the fourth interval to generate a second sub-sample image.
